(19) United States
(12) Patent Application Publication
(10) Pub. No.: US 2026/0131636 A1
(43) Pub. Date: May 14, 2026

(54) REFRIGERANT DISTRIBUTION MODULE

(71) Applicant: VALEO SYSTEMES THERMIQUES, Le Mesnil-Saint-Denis (FR)

(72) Inventors: Stephane Pernet, Le Mesnil-Saint-Denis (FR); Rody El-Chammas, Le Mesnil-Saint-Denis (FR); Patricia Gardie, Le Mesnil-Saint-Denis (FR)

(73) Assignee: VALEO SYSTEMES THERMIQUES, Le Mesnil-Saint-Denis (FR)

(21) Appl. No.: 19/121,068

(22) PCT Filed: Oct. 5, 2023
(86) PCT No.: PCT/EP2023/077528

§ 371 Date: Apr. 14, 2025

(30) Foreign Application Priority Data
Oct. 13, 2022 (FR) 2210540

(51) Int. Cl. B60H 1/32; B60H 1/00; F16L 41/03

(52) U.S. Cl. CPC B60H 1/3229; B60H 1/00271; B60H 1/3228; F16L 41/03; B60H 2001/00307

(57) ABSTRACT

A refrigerant distribution module includes a first channel connecting a first inlet and a first outlet, a second channel connecting a second inlet and a second outlet, a third channel connecting a first connection area arranged on the first channel and a third outlet, a fourth channel connecting a third inlet and a second connection area arranged on the second channel, a fifth channel connecting a fourth inlet and a third connection area arranged on the second channel, and a sixth channel connecting a fourth connection area arranged on the fifth channel and a fifth connection area arranged on the first channel. The sixth channel includes a one-way valve. Each channel is formed by an internal recess of the same basic block.

### TECHNICAL FIELD

The present invention relates to the field of thermal conditioning systems. Such thermal conditioning systems may notably be fitted to a motor vehicle. These systems allow thermal regulation of various members of the vehicle, such as the vehicle interior or an electrical energy storage battery, in the case of an electrically powered vehicle. Exchanges of heat are mainly managed by the compression and expansion of a refrigerant within multiple heat exchangers forming part of a closed circulation circuit.

### PRIOR ART

Thermal conditioning systems generally include a large number of heat exchangers and actuators for managing the flow rate and pressure of refrigerant circulating through the various heat exchangers.

A large number of components, such as shut-off valves, expansion devices, as well as the various heat exchangers, must therefore be connected to one another by a set of pipes through which the refrigerant circulates. There is therefore often a need to assemble a large number of refrigerant circulation pipes. Since the space available to accommodate these various components is limited, integrating all of the components can be problematic. In addition, the assembly of the various components and members can be tricky, owing to the difficulty in passing tools through, and checking the conformity of the assembly produced can take a long time. Moreover, when a winding path has to be created for the pipes through which the refrigerant circulates, this tends to be detrimental to thermodynamic performance.

For these reasons at least, it is desirable to have thermal conditioning systems that are easier to integrate into a confined space and less expensive to manufacture.

### SUMMARY

To this end, the present invention proposes a refrigerant distribution module, comprising:
a first refrigerant circulation channel, connecting a first refrigerant inlet and a first refrigerant outlet,
a second circulation channel connecting a second inlet and a second outlet,
a third circulation channel connecting a first connection zone arranged on the first channel and a third outlet,
a fourth circulation channel connecting a third inlet and a second connection zone arranged on the second channel between the second inlet and the second outlet,
a fifth circulation channel connecting a fourth inlet and a third connection zone arranged on the second channel between the second connection zone and the second outlet,
a sixth circulation channel connecting a fourth connection zone arranged on the fifth channel and a fifth connection zone arranged on the first channel between the first inlet and the first connection zone,
   the sixth channel comprising a one-way valve configured to allow circulation of refrigerant from the fourth connection zone to the fifth connection zone and configured to prevent circulation of refrigerant from the fifth connection zone to the fourth connection zone,
   wherein each refrigerant circulation channel is formed by an internal recess of the same basic block.

The refrigerant circulation channels are thus integrated in the structure of the refrigerant distribution module. The module does not have any protruding pipes or hoses. All of the channels making it possible to distribute refrigerant, in other words supply refrigerant to several heat exchangers and collect the refrigerant leaving these exchangers, may thus be produced by virtue of a single part. The integration of the various elements is facilitated, and the complexity reduced.

The features listed in the paragraphs below may be implemented independently of one another or in any technically possible combination:
The refrigerant distribution module may supply a thermal conditioning system, for example a thermal conditioning system for a motor vehicle.

According to one embodiment, the refrigerant distribution module comprises a seventh circulation channel connecting a fourth outlet and a sixth connection zone arranged on the first channel between the fifth connection zone and the first inlet.

This makes it possible to supply refrigerant to an additional heat exchanger, which increases the possible functions of the refrigerant distribution module.

The fluid circulation channels have a circular cross section.

The channels may thus be produced simply by machining, such as drilling.

According to one aspect of the refrigerant distribution module, the first channel comprises a first expansion valve arranged between the first connection zone and the first outlet.

The refrigerant distribution module may thus supply a first heat exchanger operating as an evaporator.

According to one aspect of the refrigerant distribution module, the third channel comprises a second expansion valve.

The refrigerant distribution module may thus also supply a second exchanger operating as an evaporator.

The first expansion valve may be an electronic expansion valve. Likewise, the second expansion valve may be an electronic expansion valve.

According to one aspect of the refrigerant distribution module, the first channel comprises a first shut-off valve arranged between the first inlet and the fifth connection zone.

The first shut-off valve is an electrically operated valve.

The second shut-off valve is an electrically operated valve.

According to the embodiment in which the module comprises a fourth outlet, the first shut-off valve is arranged between the fifth connection zone and the sixth connection zone.

The fifth channel comprises a second shut-off valve arranged between the fourth connection zone and the third connection zone.

The two shut-off valves make it possible to interrupt the circulation of the refrigerant in such a way as to allow different operating modes.

The one-way valve is a passive valve.

The one-way valve is for example a non-return valve.

According to an example of an embodiment of the refrigerant distribution module, the basic block has substantially the shape of a rectangular parallelepiped.

This shape allows for easy integration of various components such as expansion valves and shut-off valves, while optimizing compactness.

The basic block may be made of aluminum.

The basic block may thus have a moderate weight and a low manufacturing cost.

According to one aspect of the refrigerant distribution module, the refrigerant circulation channels are formed by a succession of straight cylindrical portions in fluidic communication with one another.

The circulation channels may thus be obtained simply by machining, such as drilling. This reduces the manufacturing cost of the refrigerant distribution module.

According to an example of an embodiment of the refrigerant distribution module, each refrigerant circulation channel is formed by a succession of coaxial cylindrical portions or cylindrical portions extending along intersecting axes.

For example, each refrigerant circulation channel is formed by a succession of coaxial cylindrical portions or cylindrical portions extending along perpendicular axes.

The first channel of the basic block comprises a first housing for receiving the first expansion valve.

The first housing is cylindrical and extends along an axis.

The first channel opens into the first housing, the axis of the first housing not being concurrent with the axis of the first channel.

The first expansion valve comprises a radial refrigerant inlet and an axial refrigerant outlet.

The second expansion valve comprises a radial refrigerant inlet and an axial refrigerant outlet.

The first expansion valve and the second expansion valve may be identical.

The first shut-off valve comprises a radial refrigerant inlet and an axial refrigerant outlet.

The second shut-off valve comprises a radial refrigerant inlet and an axial refrigerant outlet.

The first shut-off valve and the second shut-off valve may be identical.

The third channel of the basic block comprises a second housing for receiving the second expansion valve.

The first channel of the basic block comprises a third housing for receiving the first shut-off valve.

The fifth channel of the basic block comprises a fourth housing for receiving the second shut-off valve.

According to an example of an embodiment of the refrigerant distribution module, the second inlet and the second outlet are arranged on a first face of the basic block.

The first face is flat.

According to an example of an embodiment of the refrigerant distribution module, the third inlet and the third outlet are arranged on a second face of the basic block.

The second face is flat.

According to an example of an embodiment of the refrigerant distribution module, the first outlet is arranged on a third face of the basic block.

The first face, the second face and the third face are perpendicular in pairs.

The housing for receiving the first expansion valve and the housing for receiving the second expansion valve open onto the same face of the basic block.

The expansion valves are thus grouped together.

For example, the housing for receiving the first expansion valve and the housing for receiving the second expansion valve open onto the first face of the basic block.

The same face of the basic block receives several elements, which facilitates assembly.

According to an example of an embodiment, the first inlet and the fourth outlet are arranged on the first face of the basic block.

According to one embodiment of the refrigerant distribution module, the second channel comprises a refrigerant pressure sensor arranged between the second connection zone and the third connection zone.

The second channel may also comprise a refrigerant temperature sensor arranged between the third connection zone and the second outlet.

These two sensors provide information on the thermodynamic state of the refrigerant, allowing regulation of the thermal conditioning systems integrating the refrigerant distribution module.

According to an example of implementation of the refrigerant distribution module, the refrigerant pressure sensor and the refrigerant temperature sensor are arranged on a fourth face of the basic block, opposite the third face.

According to one embodiment, the refrigerant distribution module comprises an interface flange forming an interface with a first heat exchanger. The interface flange comprises:
a first transfer channel connecting the third outlet of the module to a refrigerant inlet of the first heat exchanger,
a second transfer channel connecting an outlet of the first heat exchanger and the third inlet of the module,
   the interface flange being rigidly secured to the basic block and the first heat exchanger.

The interface flange makes it possible to adjust the relative position of the first heat exchanger and the refrigerant distribution module.

The interface flange comprises a flat portion and two nozzles for connection to the basic block, the nozzles extending transversely to the flat portion.

According to an example of an embodiment, the first transfer channel comprises a straight slot extending along an axis parallel to the plane of extension of the flat portion.

The second transfer channel is perpendicular to the plane of extension of the flat portion.

The interface flange has the general shape of a right triangle.

According to an example of an embodiment, the straight slot of the first transfer channel is parallel to the hypotenuse of the right triangle.

The interface flange bears on a face of the basic block.

The interface flange may be brazed to the first heat exchanger.

The interface flange comprises a nozzle for connection to the third outlet and a nozzle for connection to the third inlet.

According to one embodiment, the first heat exchanger is configured to allow heat exchange between the refrigerant and a heat transfer liquid.

The first exchanger is for example a plate exchanger.

The first heat exchanger comprises a heat transfer liquid inlet nozzle and a heat transfer liquid outlet nozzle extending in parallel directions.

The first heat exchanger has the general shape of a rectangular parallelepiped.

The refrigerant inlet nozzle and the refrigerant outlet nozzle, the heat transfer liquid inlet nozzle and the heat transfer liquid outlet nozzle are arranged protruding from the same face of the first heat exchanger.

Each of the four nozzles is arranged near a corner of the same face of the first heat exchanger.

According to an example of an embodiment, the refrigerant distribution module comprises a first heat exchanger arranged in the extension of the basic block of the refrigerant distribution module.

The refrigerant distribution module may thus integrate a heat exchanger in a compact manner.

According to one embodiment, the refrigerant distribution module comprises a filter arranged partly in the first channel between the fifth connection zone and the first connection zone and partly in the third channel between the first connection zone and the housing for receiving the second expansion valve.

The filter is thus internal to the basic block, and does not modify the bulk thereof.

According to one embodiment, the refrigerant distribution module comprises a refrigerant filling valve. The filling valve is arranged in a fifth housing of the basic block, the fifth housing being in fluidic communication with the first channel.

The fifth housing is cylindrical.

The fifth connection zone opens into the fifth housing.

The fifth housing and the filter are coaxial.

Machining along the same axis thus makes it possible to jointly form the housing for the filling valve and the portion of the channel receiving the filter.

A first portion of the first channel extends between the first inlet and the housing for receiving the first shut-off valve.

A second portion of the first channel extends between the housing for receiving the first shut-off valve and the fifth connection zone.

The sixth channel is straight.

The second portion of the first channel is coaxial with the sixth channel.

Machining along the same axis thus makes it possible to jointly form the second portion of the first channel and the sixth channel.

A third portion of the first channel extends between the fifth connection zone and the housing for receiving the first expansion valve.

A fourth portion of the first channel extends between the first connection zone and the housing for receiving the first expansion valve.

A fifth portion of the first channel extends between the housing for receiving the first expansion valve and the first outlet.

A first portion of the second channel extends between the second inlet and the second connection zone.

A second portion of the second channel extends between the second connection zone and the third connection zone.

A third portion of the second channel extends between the third connection zone and the second outlet.

A first portion of the third channel extends between the first connection zone and the housing for receiving the second shut-off valve.

A second portion of the third channel extends between the housing for the second expansion valve and the third outlet.

The second portion of the third channel comprises two segments extending along perpendicular axes.

The fourth channel is straight.

The fourth channel and the second portion of the second channel are coaxial.

A first portion of the fifth channel extends between the fourth inlet and the housing for receiving the second shut-off valve.

A second portion of the fifth channel extends between the housing for receiving the second shut-off valve and the third connection zone.

According to one aspect of the refrigerant distribution module, the fourth channel, the second portion of the second channel and the housing for receiving the second shut-off valve are coaxial.

Machining along the same axis thus makes it possible to jointly form the fourth channel, the second portion of the second channel and the housing for receiving the second shut-off valve.

The sixth channel is straight.

The fourth connection zone opens into the housing for receiving the second shut-off valve.

The disclosure also relates to a thermal conditioning system for a motor vehicle, comprising:
a first heat exchanger configured to operate as an evaporator,
a second heat exchanger configured to operate as an evaporator,
a refrigerant distribution module as described above, in which:
   an inlet of the first exchanger is connected to the third outlet,
   an outlet of the first exchanger is connected to the third inlet,
   an inlet of the second exchanger is connected to the first outlet,
   an outlet of the second exchanger is connected to the second inlet,
a first refrigerant circulation branch comprising, successively in a direction of circulation of the refrigerant:
   a compressor comprising at least one inlet and one outlet,
   a condenser,
   a third expansion device,
   a third heat exchanger configured to operate selectively as an evaporator or as a condenser,
      an outlet of the third exchanger being connected to the fourth inlet of the distribution module, and the inlet of the compressor being connected to the second outlet,
a second refrigerant circulation branch, connecting a junction point arranged on the first circulation branch to the first inlet of the distribution module.

According to one embodiment of the thermal conditioning system:
the first exchanger is configured to be thermally coupled to an element of an electric powertrain of a motor vehicle,
the second heat exchanger is configured to exchange heat with an internal air stream inside a vehicle interior,
the third heat exchanger is configured to exchange heat with an internal air stream inside a vehicle interior.

The refrigerant module is thus integrated in a thermal conditioning system that can operate in vehicle interior cooling mode, in heat pump mode or in interior dehumidification mode, while ensuring thermal conditioning of an element of the vehicle powertrain. Most of the necessary components are integrated in the module, allowing compact integration of the thermal conditioning system.

The element of the electric powertrain may comprise an electrical energy storage battery.

The element of the electric powertrain may comprise an electronic module for controlling an electric drive motor of the vehicle.

The first refrigerant circulation branch comprises a refrigerant accumulation device arranged between the condenser and the junction point.

### BRIEF DESCRIPTION OF THE DRAWINGS

Further features, details and advantages will become apparent on reading the detailed description below, and on studying the attached drawings, in which:

FIG. 1 is a schematic view of a thermal conditioning system integrating a distribution module according to a first embodiment,

FIG. 2 is a schematic view of a thermal conditioning system integrating a distribution module according to a second embodiment,

FIG. 3 is a schematic view, in perspective, of the refrigerant distribution module shown schematically in FIG. 1,

FIG. 4 is a detail view, in perspective, of a basic block forming part of the refrigerant distribution module of FIG. 1,

FIG. 5 is another detail view, in perspective, of the basic block of FIG. 4,

FIG. 6 is a perspective view of the refrigerant distribution module shown schematically in FIG. 1,

FIG. 7 is another perspective view of the refrigerant distribution module of FIG. 6,

FIG. 8 is another detail view, in perspective, of the basic block of FIG. 4,

FIG. 9 is another detail view, in perspective, of the basic block of FIG. 4,

FIG. 10 is an exploded view, in perspective, of part of the refrigerant distribution module of FIGS. 6 and 7,

FIG. 11 is another exploded view, in perspective, of part of the refrigerant distribution module of FIGS. 6 and 7,

FIG. 12 is another view showing certain components of the refrigerant distribution module of FIGS. 6 and 7.

### DESCRIPTION OF THE EMBODIMENTS

To make the figures easier to read, the various elements are not necessarily shown to scale. In these figures, identical elements bear the same reference signs. Certain elements or parameters may be indexed, that is to say designated for example as the first element or the second element, or indeed the first parameter and the second parameter, etc. The aim of this indexing is to differentiate between elements or parameters which are similar but not identical. This indexing does not imply the priority of one element or parameter over another, and the denominations may be interchanged.

The expression “a second element is placed between a first element and a third element” means that the shortest path for traveling from the first element to the third element passes via the second element.

When it is specified that a sub-system has a given element, this does not rule out the presence of other elements in this sub-system.

The thermal conditioning system 100 that will be described may be fitted to a motor vehicle. A compression device 7 makes it possible to circulate a refrigerant in a closed refrigerant circulation circuit 10. The compression device 7 may be an electric compressor, i.e. a compressor the movable parts of which are driven by an electric motor. The compression device 7 comprises a side for aspiration of the refrigerant at low pressure, also known as the inlet 7a of the compression device, and a side for delivery of the refrigerant at high pressure, also known as the outlet 7b of the compression device. The internal moving parts of the compressor 7 take the refrigerant from low pressure on the inlet 7a side to high pressure on the outlet 7b side. After expansion in one or more expansion devices, the refrigerant returns to the inlet 7a of the compressor 7 and begins a new thermodynamic cycle.

An electronic control unit 60 receives information from various sensors that notably measure the characteristics of the refrigerant. The electronic control unit 60 also receives instructions issued by the occupants of the vehicle, such as for example the desired temperature inside the vehicle interior. The electronic control unit 60 implements control laws making it possible to control various actuators, in order to control the thermal conditioning system 100 so as to carry out the instructions received.

The refrigerant circulation circuit 10 has several offshoots connected to one another. Each junction point allows the refrigerant to enter one or the other of the circuit portions that meet at this junction point. The refrigerant is distributed between the circuit portions meeting at a junction point by adjusting the opening or closure of the shut-off valve, non-return valve or expansion device included on each of the branches. In other words, each junction point is a means for redirecting the refrigerant arriving at this junction point. Shut-off valves and non-return valves thus make it possible to selectively direct the refrigerant into the various branches of the refrigerant circuit in order to provide different modes of operation, as will be described below.

The refrigerant used by the refrigerant circuit 10 is in this case a chemical fluid such as R1234yf. Other refrigerants may also be used, such as R134a, R290 or R744.

In the various figures, the axis X corresponds to the longitudinal axis of the module 50, the axis Y corresponds to the transverse axis of the module 50, and the axis Z corresponds to a third axis perpendicular to the other two axes. The longitudinal axis X may coincide with the longitudinal axis of the vehicle when the distribution module 50 is in its nominal position of installation in the vehicle. Likewise, the transverse axis Y may correspond to the transverse axis of the vehicle. The axis Z may correspond to the vertical axis. Another orientation of module 50 is however possible.

Within the meaning of the present application, the terms ‘channel’ and ‘refrigerant circulation channel’ are equivalent. Each channel has exactly one inlet and one outlet. In other words, a channel is not branched. The circuit portions arranged in parallel are formed by at least two separate channels. Each inlet of the module is a refrigerant inlet and each outlet is a refrigerant outlet.

Each connection zone establishes fluidic communication between two channels. A connection zone is delimited by the intersection between two channels. It is referred to as a connection zone and not a connection point because the fluid circulation channels are volume elements. Each connection zone forms a tapping means from one channel to another channel.

FIG. 6 shows a refrigerant distribution module 50 that can be integrated in a thermal conditioning system 100 of a motor vehicle.

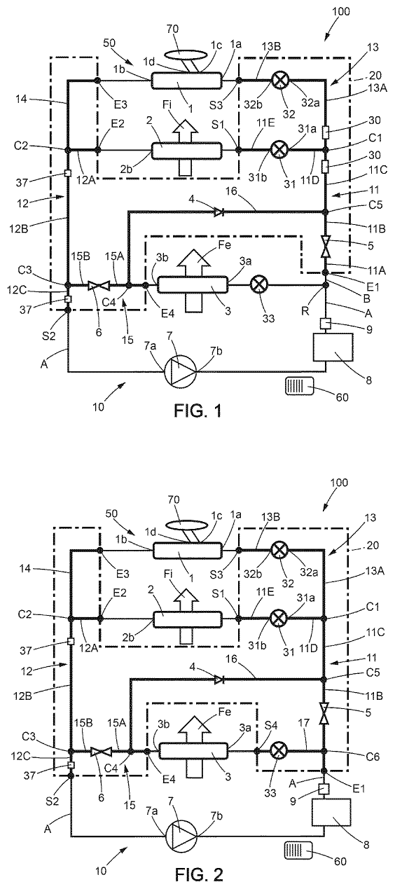

The schematic diagram of this thermal conditioning system 100 integrating the distribution module 50 is shown in FIG. 1.

The refrigerant distribution module 50 comprises:
a first refrigerant circulation channel 11, connecting a first refrigerant inlet E1 and a first refrigerant outlet S1,
a second circulation channel 12 connecting a second inlet E2 and a second outlet S2,
a third circulation channel 13 connecting a first connection zone C1 arranged on the first channel 11 and a third outlet S3,
a fourth circulation channel 14 connecting a third inlet E3 and a second connection zone C2 arranged on the second channel 12 between the second inlet E2 and the second outlet S2,
a fifth circulation channel 15 connecting a fourth inlet E4 and a third connection zone C3 arranged on the second channel 12 between the second connection zone C2 and the second outlet S2,
a sixth circulation channel 16 connecting a fourth connection zone C4 arranged on the fifth channel 15 and a fifth connection zone C5 arranged on the first channel 11 between the first inlet E1 and the first connection zone C1.

The sixth channel 16 comprises a one-way valve 4 configured to allow circulation of refrigerant from the fourth connection zone C4 to the fifth connection zone C5 and configured to prevent circulation of refrigerant from the fifth connection zone C5 to the fourth connection zone C4.

Each refrigerant circulation channel 11, 12, 13, 14, 15, 16 is formed by an internal recess of the same basic block 20.

The refrigerant circulation channels 11, 12, 13, 14, 15, 16 are thus integrated in the structure of the refrigerant distribution module 50. The module 50 does not have any protruding pipes or hoses. All of the channels making it possible to distribute refrigerant, in other words supply refrigerant to several heat exchangers and collect the refrigerant leaving these exchangers, may thus be produced by virtue of a single part. The integration of the various elements is facilitated, because the module may be a compact part. Integration complexity is also reduced, since a standard part may be used for different applications.

In FIG. 1, the dotted line delimits the part of the schematic diagram which forms part of the basic block 20 of the distribution module 50 according to the first embodiment.

The refrigerant distribution module 50 may supply a thermal conditioning system, for example a thermal conditioning system for a motor vehicle.

FIG. 2 schematically shows a thermal conditioning system 100 comprising a distribution module 50 according to a second embodiment. The schematic diagram of the thermal conditioning system 100 is unchanged with respect to FIG. 1, but the refrigerant distribution module 50 integrates an additional portion of the refrigerant circuit 10. As before, the dotted line indicates the part of the schematic diagram included in the basic block 20.

According to this second embodiment, the refrigerant distribution module 50 comprises a seventh circulation channel 17 connecting a fourth outlet S4 and a sixth connection zone C6. The sixth connection zone C6 is arranged on the first channel 11 between the fifth connection zone C5 and the first inlet E1.

This second embodiment differs from the first by the presence of an additional outlet S4. This makes it possible to supply refrigerant to an additional heat exchanger, which increases the possible functions of the refrigerant distribution module.

In this case the fluid circulation channels have a circular cross section. The channels may thus be produced simply by machining, such as drilling the basic block 20.

The diameter of the refrigerant circulation channels is between 8 millimeters and 30 millimeters.

The first channel 11 comprises a first expansion valve 31 arranged between the first connection zone C1 and the first outlet S1.

The refrigerant distribution module 50 may thus supply a heat exchanger with refrigerant at low pressure. This heat exchanger 2 may thus operate as an evaporator.

The third channel 13 comprises a second expansion valve 32. The second expansion valve 32 is arranged between the first connection zone C1 and the third outlet S3.

The refrigerant distribution module 50 may thus also supply another heat exchanger operating as an evaporator with refrigerant at low pressure.

The first expansion valve 31 may be an electronic expansion valve. Likewise, the second expansion valve 32 may be an electronic expansion valve.

In an electronic expansion valve, the passage section allowing the refrigerant to pass through can be adjusted continuously between a closure position and a maximum opening position. To this end, a control unit 60 of the thermal conditioning system 100 controls an electric motor that moves a movable shut-off device controlling the passage section available to the refrigerant.

The first channel 11 comprises a first shut-off valve 5 arranged between the first inlet E1 and the fifth connection zone C5.

The first shut-off valve 5 is in this case an electrically operated valve.

According to the second embodiment, in which the refrigerant distribution module 50 comprises a fourth outlet S4, the first shut-off valve 5 is arranged between the fifth connection zone C5 and the sixth connection zone C6.

The fifth channel 15 comprises a second shut-off valve 6 arranged between the fourth connection zone C4 and the third connection zone C3.

The second shut-off valve 6 is also an electrically operated valve.

An electronic control unit 60 may independently control the opening and closing of the first shut-off valve 5 and the second shut-off valve 6. In other words, the state of one shut-off valve does not depend on the state of the other shut-off valve. The two shut-off valves 5, 6 make it possible to interrupt the circulation of the refrigerant in such a way as to allow different operating modes.

The one-way valve 4 is a passive valve. The one-way valve 4 is for example a non-return valve.

The one-way valve 4 is entirely contained inside the basic block 20. In other words, once the basic block 20 is equipped with all the components for managing the circulation and expansion of refrigerant, the one-way valve 4 is no longer visible and is no longer accessible.

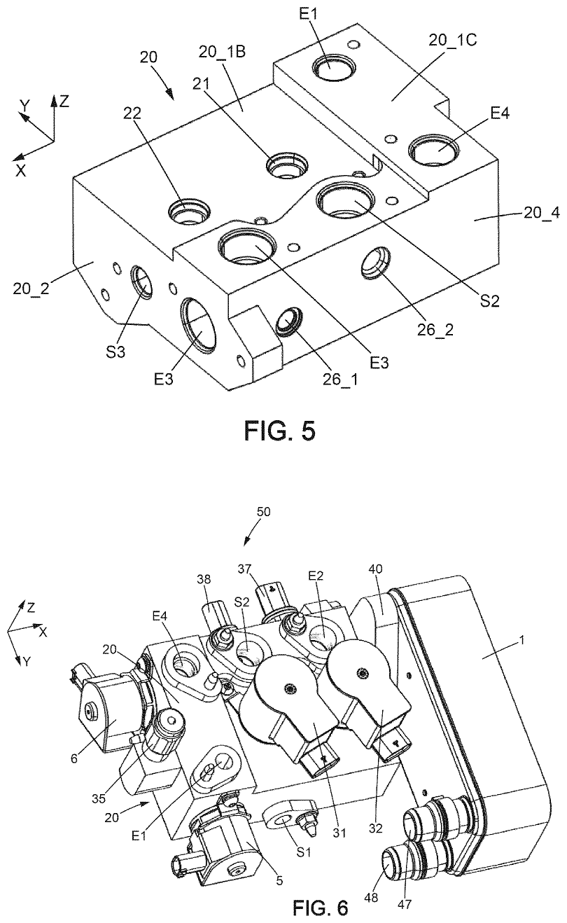

FIG. 4 and FIG. 5 show the basic block 20 in isolation.

According to the example of an embodiment shown, the basic block 20 has substantially the shape of a rectangular parallelepiped. This shape allows for easy integration of various components such as expansion valves and shut-off valves, while optimizing compactness.

The basic block 20 has six faces. Two faces are parallel to the plane defined by the directions X and Y. Two other faces are parallel to the plane defined by the directions Y and Z. Two other faces are parallel to the plane defined by the directions X and Z. The basic block may include areas projecting from the faces, allowing attachment to the vehicle.

The basic block 20 may be made of aluminum. The basic block 20 may thus have a moderate weight and a low manufacturing cost.

The basic block 20 is for example obtained by extrusion. Internal defects such as porosity are thus avoided. The refrigerant circulation channels are formed by machining the basic block 20. Machining of a solid block obtained by extrusion is possible. The machined surfaces are in contact with the refrigerant. Thanks to the lack of porosity, sealing of the basic block 20 is guaranteed, even when the refrigerant is at high pressure.

The height of the basic block 20, in other words the dimension along the axis Z in the figures, is between 90 millimeters and 130 millimeters.

The width of the basic block 20, in other words the dimension along the axis Y in the figures, is between 180 millimeters and 240 millimeters.

The length of the basic block, in other words the dimension along the axis X in the figures, is between 200 millimeters and 280 millimeters.

The refrigerant circulation channels 11, 12, 13, 14, 15, 16 are formed by a succession of straight cylindrical portions in fluidic communication with one another.

The circulation channels may thus be obtained simply by machining, such as drilling. This reduces the manufacturing cost of the refrigerant distribution module.

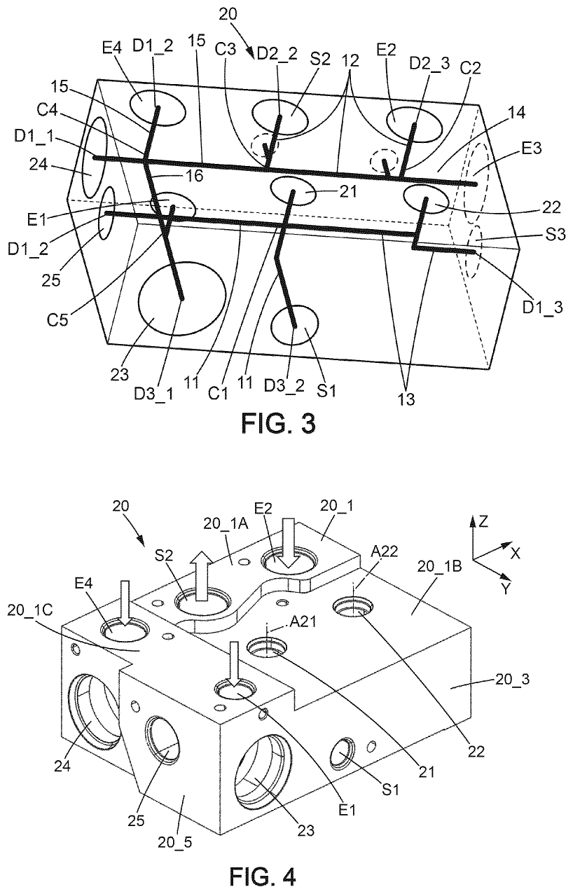

In FIG. 3, the thick black lines schematically indicate the drilling direction making it possible to create the various channels. In this figure, variations in the section of the channels are not depicted, only the direction in which each channel may be created by drilling is depicted.

The line denoted D1_1 corresponds to a first drilling direction. This drilling direction makes it possible in particular to create a part of the fifth channel 15, a part of the second channel 12 and the fourth channel 14. The line D1_2 indicates the second drilling direction, parallel to D1_1. This drilling makes it possible in particular to create a part of the first channel 11 and a part of the third channel 13. The line D1_3 denotes a third drilling direction, parallel to D1_1 and to D1_2. This drilling makes it possible to create another part of the third channel 13, as well as the third outlet S3. Likewise, the drilling directions denoted D2_1, D2_2, D2_3 are parallel to one another. The direction D2_1 makes it possible to create the fourth inlet E4 and part of the fifth channel 15. The direction D2_2 makes it possible to create the second outlet S2 and part of the second channel 12. The direction D2_3 makes it possible to create the second inlet E2 and another part of the second channel 12.

Likewise, the directions denoted D3_1 and D3_2 are parallel and make it possible to create in particular other parts of channels. In FIG. 3, the different drilling directions, in particular D1_1 to D1_3, D2_1 and D2_2, D3_1 and D3_2, are shown in thick solid lines even for portions not visible from the outside because they are hidden by an outer surface of the basic block 20.

According to the example shown, each refrigerant circulation channel 11, 12, 13, 14, 15, 16 is formed by a succession of coaxial cylindrical portions or cylindrical portions extending along intersecting axes.

For example, each refrigerant circulation channel is formed by a succession of coaxial cylindrical portions or cylindrical portions extending along perpendicular axes.

The first channel 11 of the basic block 20 comprises a first housing 21 for receiving the first expansion valve 31. The first housing 21 is cylindrical and extends along an axis A21.

The first channel 11 opens into the first housing 21. The axis A21 of the first housing 21 is not concurrent with the axis of the first channel 11.

The first expansion valve 31 comprises a radial refrigerant inlet 31a and an axial refrigerant outlet 31b.

The housing 21 for the first expansion valve 31 has a cylindrical shape. The housing 21 comprises a first cylindrical part extending into a second coaxial cylindrical part, the diameter of which is smaller than the diameter of the first part. The housing 21 comprises a female thread into which a thread 29 of the first expansion valve 31 may engage in order to secure the first expansion valve 31.

The first channel 11 comprises a portion 11C upstream of the first expansion valve 31 which opens onto the cylindrical periphery of the first cylindrical part of the receiving housing 21. The first channel 11 comprises a portion 11D downstream of the first expansion valve 31, which comprises the second cylindrical part of the housing 21. A first seal 27 ensures sealing of the housing 21 from the outside when the first expansion valve 31 is mounted in the module 50. A second seal 28 ensures sealing of the receiving housing 21 from the downstream portion 11D of the first channel 11. Thus, when the expansion valve 31 is mounted in the receiving housing 21, the refrigerant may pass from the upstream portion 11C of the first channel 11 to the downstream portion 11D only by circulating through the expansion valve 31. The passage section for the refrigerant through the first expansion valve 31 may vary continuously as a function of the position of a movable shut-off device. The movable shut-off device is operated by an electric motor driving an actuating mechanism.

The third channel 13 of the basic block 20 comprises a second housing 22 for receiving the second expansion valve 32. The second expansion valve 32 is arranged between the first connection zone C1 and the third outlet S3.

The housing 22 for the second expansion valve 32 may be identical to the housing 21 for the first expansion valve 31, in other words they have the same shape and the same dimensions.

The second expansion valve 32 comprises a radial refrigerant inlet 32a and an axial refrigerant outlet 32b. The second expansion valve 32 operates according to the same principle as the first expansion valve 31.

The first expansion valve 31 and the second expansion valve 32 may be identical.

Part A of FIG. 12 depicts the expansion valves 31, 32 not mounted on the module 50. Part B of FIG. 12 depicts the shut-off valves 5, 6 not mounted on the module 50.

The first shut-off valve 5 comprises a radial refrigerant inlet 5a and an axial refrigerant outlet 5b.

The second shut-off valve 6 comprises a radial refrigerant inlet 6a and an axial refrigerant outlet 6b.

The first shut-off valve 5 and the second shut-off valve 6 may be identical.

The first shut-off valve 5 and the second shut-off valve 6 operate according to a principle identical to the first expansion valve 31 and the second expansion valve 32 in terms of the arrangement of the refrigerant inlets and outlets. The first shut-off valve 5 and the second shut-off valve 6 have two stable operating positions: a closed position, in which the flow rate of refrigerant through the valve is zero, and an open position in which the refrigerant may pass through the valve, the passage section being constant. Zero flow rate means zero except for leaks.

In part A of FIG. 12, the arrows in dotted lines F1 schematically indicate for the expansion valves 31, 32 the refrigerant entering through the various inlet ports of a radial inlet, and the arrows in solid lines F2 illustrate the refrigerant leaving from the axial outlet.

In part B of FIG. 12, the arrows F3 schematically indicate the refrigerant entering the shut-off valves 5, 6 through the multiple ports of the radial inlet, and the arrow F4 schematically indicates the refrigerant leaving through the axial outlet.

The first channel 11 of the basic block 20 comprises a third housing 23 for receiving the first shut-off valve 5.

The housing 23 for the first shut-off valve 5 comprises a first cylindrical chamber 23_1 having a side wall and a bottom 49 of annular shape. The housing 23 also comprises a second chamber 23_2, also cylindrical, coaxial with the first chamber 23_1, and opening into the bottom 49 of the first chamber 23_1. The radial inlet of the first shut-off valve 5 opens into the first cylindrical chamber 23_1. The axial outlet of the first shut-off valve 5 opens into the second cylindrical chamber 23 2.

The fifth channel 15 of the basic block 20 comprises a fourth housing 24 for receiving the second shut-off valve 6. The fourth housing 24 is similar to the third housing 23.

According to the example shown, in particular in FIG. 4, the second inlet E2 and the second outlet S2 are arranged on a first face 20_1 of the basic block 20. The first face 20_1 is flat.

The second inlet E2 and the second outlet S2 are in this case arranged on a flat portion 20_1A of a first face 20_1 of the basic block 20. As shown in particular in FIG. 4, the first face 20_1 comprises two flat portions 20_1A and 20_1B offset from one another along the axis Z perpendicular to the two flat portions. The second flat portion 20_1B may be formed by a counterbore on the first face of the basic block 20. The offset between the two flat portions 20_1A and 20_1B makes it possible to reduce the bulk in the direction Z.

As can be seen in FIG. 5, the third inlet E3 and the third outlet S3 are arranged on a second face 20_2 of the basic block 20.

The second face 20_2 is in this case flat.

As can be seen in particular in FIG. 4, the first outlet S1 is arranged on a third face 20_3 of the basic block 20. The third face 20_3 is in this case flat.

The first face 20_1, the second face 20_2 and the third face 20_3 are perpendicular in pairs.

The housing for receiving 21 the first expansion valve 31 and the housing for receiving 22 the second expansion valve 32 open onto the same face of the basic block 20.

The two expansion valves 31, 32 are thus grouped together.

The housing for receiving 21 the first expansion valve 31 and the housing for receiving 22 the second expansion valve 32 open onto the first face 20_1 of the basic block 20.

The same face of the basic block receives several elements, which facilitates assembly.

More specifically, the housing for receiving 21 the first expansion valve 31 and the housing for receiving 22 the second expansion valve 32 open onto the second flat portion 20_1B of the first face 20_1.

The first inlet E1 and the fourth outlet E4 are arranged on the first face 20_1 of the basic block 20.

More specifically, the first face 20_1 comprises a third flat portion 20_1C offset relative to the two flat portions 20_1A, 20_1B along the axis Z perpendicular to the three flat portions 20_1A, 20_1B, 20_1C.

The housing for receiving 21 the first expansion valve 31 and the housing for receiving 22 the second expansion valve 32 open onto the third flat portion 20_1C of the first face 20_1.

The second channel 12 in this case comprises a refrigerant pressure sensor 37 arranged between the second connection zone C2 and the third connection zone C3.

The second channel 12 also comprises a refrigerant temperature sensor 38 arranged between the third connection zone C3 and the second outlet S2.

These two sensors 37, 38 provide information on the thermodynamic state of the refrigerant, allowing regulation of the thermal conditioning systems integrating the refrigerant distribution module.

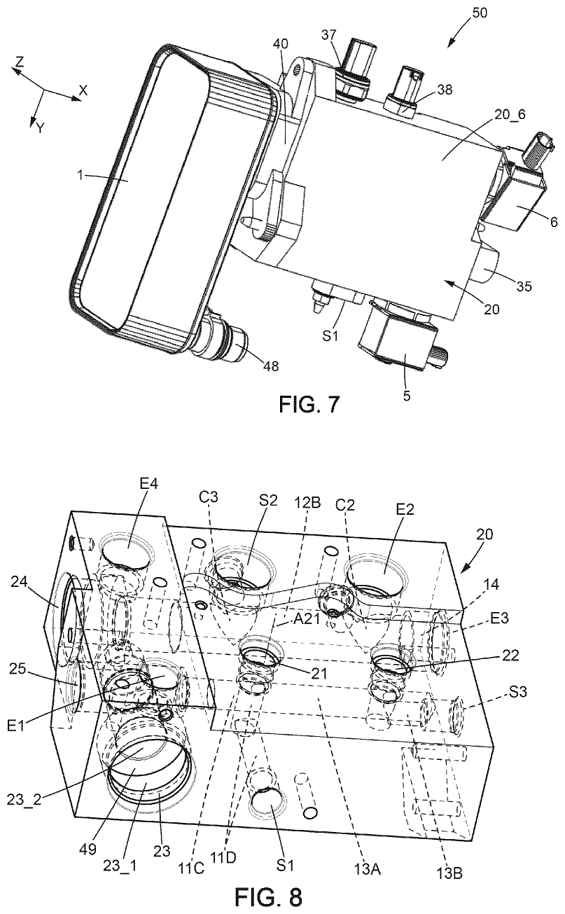

According to the example shown, in particular in FIG. 6 and in FIG. 7, the refrigerant pressure sensor 37 and the refrigerant temperature sensor 38 are arranged on a fourth face 20 4 of the basic block 20, opposite the third face 20_3.

More specifically, the pressure sensor 37 is arranged in a housing 26_1 opening onto the fourth face 20_4 of the basic block 20. The temperature sensor 38 is arranged in a housing 26_2 opening onto the fourth face 20_4 of the basic block 20. The sensors 37, 38 are screwed into their respective housings 26_1, 26_2 and a seal ensures sealing from the outside of the module 50. The active element of each sensor is in contact with the refrigerant. The two sensors 37, 38 make it possible to know the state of the low-pressure refrigerant which will come out of the basic block via the second outlet S2.

As shown in FIG. 7, only the face 20_6 of the basic block 20 has no opening. This face may thus be in contact with a part of the vehicle supporting the module 50. In the various figures, the device for attaching the module 50 to the vehicle has not been shown.

According to the example illustrated, the refrigerant distribution module 50 comprises an interface flange 40 forming an interface with a first heat exchanger 1. The interface flange 40 comprises:
a first transfer channel 41 connecting the third outlet S3 of the module 50 to a refrigerant inlet 1a of the first heat exchanger 1,
a second transfer channel 42 connecting an outlet 1b of the first heat exchanger 1 and the third inlet E3 of the module 50.

The interface flange 40 is rigidly secured to the basic block 20 and the first heat exchanger 1.

The interface flange 40 is interposed between the first exchanger 1 and the second face 20_2 of the basic block 20. The interface flange 40 makes it possible to adjust the relative position of the first heat exchanger 1 and the refrigerant distribution module 50, in other words to make the inlets/outlets of the first exchanger 1 coincide with the corresponding inlets/outlets of the basic block 20.

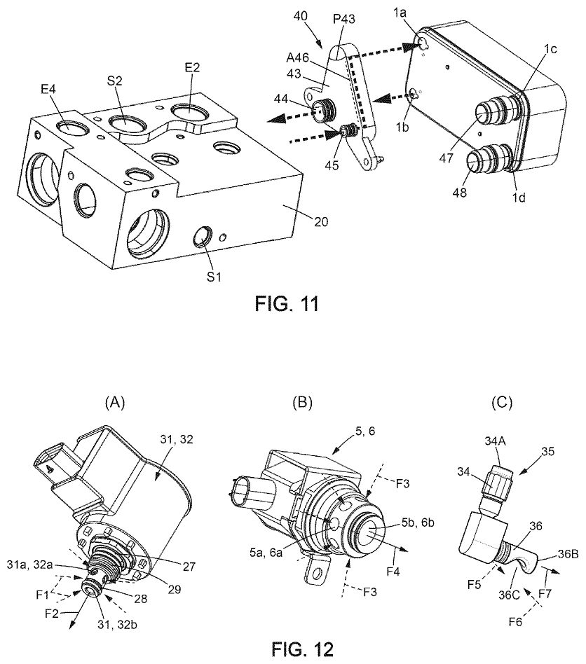

The interface flange 40 is shown in detail in FIG. 10 and FIG. 11. The interface flange 40 comprises a flat portion 43 and two nozzles for connection 44, 45 to the basic block 20. The nozzles 44, 45 extend transversely to the flat portion 43.

The first transfer channel 41 comprises a straight slot 46 extending along an axis parallel to the plane of extension of the flat portion 43. The second transfer channel 42 is perpendicular to the plane of extension P43 of the flat portion 43.

The interface flange 40 has the general shape of a right triangle. The straight slot 46 of the first transfer channel 41 is parallel to the hypotenuse of the right triangle.

The interface flange 40 bears on a face of the basic block 20. The interface flange 40 bears on the second face 20_2 of the basic block 20 when the module 50 is assembled.

The interface flange 40 comprises a nozzle 44 for connection to the third outlet S3 and a nozzle 45 for connection to the third inlet E3. When the module 50 is assembled, the nozzle 44 is inserted in the third outlet S3 and the nozzle 45 is inserted in the third inlet E3. Each nozzle 44, 45 comprises two cylindrical grooves. Two O-rings, not numbered in the figures, are each arranged in a groove of a nozzle in such a way as to ensure sealing with the basic block 20.

The interface flange 40 may be brazed to the first heat exchanger 1. In this case, the interface flange 40 and the first exchanger 1 form a non-dismantleable assembly. The first exchanger 1 and the basic block 20 are assembled simply by inserting the two nozzles 44, 45 in the basic block 20. In other words, the refrigerant distribution module 50, as shown in FIGS. 6 and 7, integrates the interface flange 40 and the first exchanger 1. It also integrates the two expansion valves 31, 32, the two shut-off valves 5, 6 and the two pressure and temperature sensors 37, 38.

According to the example illustrated, the first heat exchanger 1 is configured to allow heat exchange between the refrigerant and a heat transfer liquid. The signs 1a, 1b correspond to the refrigerant inlets/outlets and the signs 1c, 1d to the heat transfer liquid inlets/outlets. The heat transfer liquid is for example a mixture of water and glycol.

The first exchanger 1 is for example a plate exchanger.

The first heat exchanger 1 has the general shape of a rectangular parallelepiped.

The first heat exchanger 1 comprises a heat transfer liquid inlet nozzle 47 and a heat transfer liquid outlet nozzle 48 extending in parallel directions.

The refrigerant inlet nozzle 45, the refrigerant outlet nozzle 44, the heat transfer liquid inlet nozzle 47 and the heat transfer liquid outlet nozzle 48 are arranged protruding from the same face of the first heat exchanger 1. Each of the four nozzles 44, 45, 46, 47 is arranged near a corner of the same face of the first heat exchanger 1.

The first heat exchanger 1 is arranged in the extension of the basic block 20 of the refrigerant distribution module 50.

The refrigerant distribution module 50 may thus integrate a heat exchanger in a particularly compact manner. The interface flange 40 allows this compact arrangement, without being detrimental to the thermodynamic performance of the first exchanger 1. This is because the second channel 42 is completely straight, which means that the pressure loss between the outlet 1b of the first exchanger 1 and the third inlet E3 of the basic block is negligible.

The refrigerant distribution module 50 also comprises a filter 30. The filter 30 is arranged partly in the first channel 11 between the fifth connection zone C5 and the first connection zone C1. The filter 30 is also arranged partly in the third channel 13 between the first connection zone C1 and the housing for receiving 22 the second expansion valve 32.

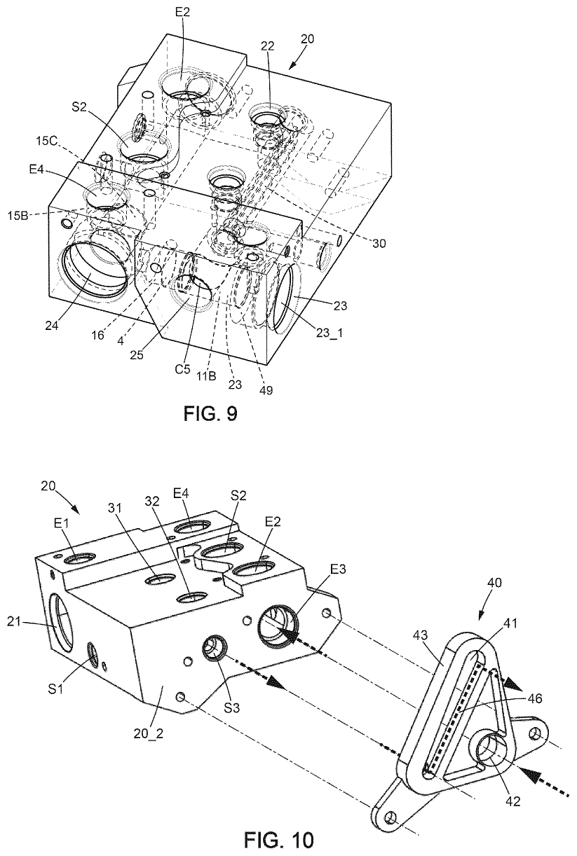

The filter 30 is thus internal to the basic block 20, and does not modify the bulk thereof. The arrangement of the filter 30 is shown in detail in FIG. 9. The installation of the filter 30 does not require any specific machining, since the filter is simply inserted in the channels already formed. In the schematic diagram of FIG. 1, the filter 30 has been shown in two separate parts, so as to simplify the depiction. In the example of FIG. 9, the filter 30 is in one piece.

The filter 30 comprises a cylindrical support structure on which a filter mesh is arranged, forming a cylindrical chamber. The refrigerant is taken into the cylindrical chamber and comes out filtered by the lateral surface formed by the filter mesh. The filtered refrigerant reaches the inlet of the first expansion valve 31 and the second expansion valve 32.

The refrigerant distribution module 50 comprises a refrigerant filling valve 35. The filling valve 35 is arranged in a fifth housing 25 of the basic block 20, the fifth housing 25 being in fluidic communication with the first channel 11.

The fifth housing 25 is cylindrical.

The fifth connection zone C5 opens into the fifth housing 25.

The fifth housing 25 and the filter 30 are coaxial.

Machining along the same axis thus makes it possible to jointly form the housing 25 for the filling valve 35 and the portion of the channel receiving the filter 30. During assembly of the module 50, the filter 30 is inserted and put in place, then the filling valve 35 is inserted in its housing 25.

Part C of FIG. 12 shows the filling valve 35 in detail. The filling valve 35 comprises a filling element 34 and a tubular portion 36. The filling element 34 is external to the basic block 20. The tubular portion 36 is inserted in the basic block 20. The tubular portion 36 comprises an axial outlet 36B and a recess 36C allowing radial communication with the fifth connection zone C5. In the recess 36C, the flow of refrigerant F5 circulating in the sixth channel 16 and coming from the one-way valve 4 joins the flow of refrigerant F6 circulating in the portion 11B of the first channel 11, and the two mixed flows, denoted F7, leave through the axial outlet 36 in the direction of the filter 30.

The arrangement of the various portions of the refrigerant circulation channels, including the connection zones between channels, will be described in detail below.

A first portion 11A of the first channel 11 extends between the first inlet E1 and the housing for receiving 23 the first shut-off valve 5.

A second portion 11B of the first channel 11 extends between the housing for receiving 23 the first shut-off valve 5 and the fifth connection zone C5.

The sixth channel 16 is straight.

The second portion 11B of the first channel 11 is coaxial with the sixth channel 16.

Machining along the same axis thus makes it possible to jointly form the second portion 11B of the first channel 11 and the sixth channel 16.

A third portion 11C of the first channel 11 extends between the fifth connection zone C5 and the housing for receiving 21 the first expansion valve 31.

A fourth portion 11D of the first channel 11 extends between the first connection zone C1 and the housing for receiving 21 the first expansion valve 31.

A fifth portion 11E of the first channel 11 extends between the housing for receiving 21 the first expansion valve 31 and the first outlet S1.

A first portion 12A of the second channel 12 extends between the second inlet E2 and the second connection zone C2.

A second portion 12B of the second channel 12 extends between the second connection zone C2 and the third connection zone C3.

A third portion 12C of the second channel 12 extends between the third connection zone C3 and the second outlet S2.

A first portion 13A of the third channel 13 extends between the first connection zone C1 and the housing for receiving 24 the second shut-off valve 6.

A second portion 13B of the third channel 13 extends between the housing 22 for the second expansion valve 32 and the third outlet S3.

The second portion 13B of the third channel 13 comprises two segments extending along perpendicular axes.

The fourth channel 14 is straight.

The fourth channel 14 and the second portion 12B of the second channel 12 are coaxial.

A first portion 15A of the fifth channel 15 extends between the fourth inlet E4 and the housing for receiving 24 the second shut-off valve 6.

A second portion 15B of the fifth channel 15 extends between the housing for receiving 24 the second shut-off valve 6 and the third connection zone C3.

The fourth channel 14, the second portion 12B of the second channel 12 and the housing for receiving 24 the second shut-off valve 6 are coaxial.

Machining along the same axis thus makes it possible to jointly form the fourth channel 14, the second portion 12B of the second channel 12 and the housing for receiving 24 the second shut-off valve 6. Moreover, the passage section of the fourth channel 14 and of the second portion 12B of the second channel 12 may be selected in such a way as to reduce the pressure loss so as to optimize the thermodynamic performance of the thermal conditioning system 100 on which the refrigerant distribution module 50 is mounted. In other words, the channels through which low-pressure refrigerant flows may have a larger diameter than the channels through which high-pressure refrigerant flows.

The sixth channel 16 is straight.

The fourth connection zone C4 opens into the housing for receiving 24 the second shut-off valve 6.

The operation of a thermal conditioning system 100 in which the refrigerant distribution module 50 is integrated will now be described.

The thermal conditioning system 100 for a motor vehicle, shown schematically in FIG. 1, comprises:
a first heat exchanger 1 configured to operate as an evaporator,
a second heat exchanger 2 configured to operate as an evaporator,
a refrigerant distribution module 50 as described above, in which:
   an inlet of the first exchanger 1 is connected to the third outlet S3,
   an outlet of the first exchanger 1 is connected to the third inlet E3,
   an inlet of the second exchanger 2 is connected to the first outlet S1,
   an outlet of the second exchanger 2 is connected to the second inlet E2,
a first refrigerant circulation branch A comprising, successively in a direction of circulation of the refrigerant:
   a compressor 7 comprising at least one inlet 7a and one outlet 7b,
   a condenser 8,
   a third expansion device 33,
   a third heat exchanger 3 configured to operate selectively as an evaporator or as a condenser,
      an outlet of the third exchanger 3 being connected to the fourth inlet E4 of the distribution module 50, and the inlet 7a of the compressor 7 being connected to the second outlet S2,
a second refrigerant circulation branch B, connecting a junction point R arranged on the first circulation branch A to the first inlet E1 of the distribution module 50.

The condenser 8 dissipates the heat of condensation of the refrigerant into a heat transfer fluid. The heat transfer fluid may be an internal air stream inside a vehicle interior. The heat transfer fluid may also be a heat transfer liquid circulating in a heat transfer liquid circuit. The heat transfer liquid circuit may comprise a heat exchanger configured to exchange heat with an internal air stream Fi inside a vehicle interior.

According to the example of the thermal conditioning system 100 shown:
the first exchanger 1 is configured to be thermally coupled to an element 70 of an electric powertrain of a motor vehicle,
the second heat exchanger 2 is configured to exchange heat with an internal air stream Fi inside a vehicle interior,
the third heat exchanger 3 is configured to exchange heat with an internal air stream Fi inside a vehicle interior.

The refrigerant module 50 is thus integrated in a thermal conditioning system 100 that can operate in vehicle interior cooling mode, in heat pump mode or in interior dehumidification mode, while ensuring thermal conditioning of an element of the vehicle powertrain. Most of the necessary components are integrated in the module 50, allowing compact integration of the thermal conditioning system.

The element 70 of the electric powertrain may comprise an electrical energy storage battery.

The element 70 of the electric powertrain may comprise an electronic module for controlling an electric drive motor of the vehicle.

The first refrigerant circulation branch A comprises a refrigerant accumulation device 9 arranged between the condenser 8 and the junction point R.

The refrigerant accumulation device 9 is a receiver dryer.

Alternatively, the thermal conditioning system 100 may comprise a refrigerant accumulator arranged between the second outlet S2 and the inlet 7a of the compressor.

The thermal conditioning system 100 for a motor vehicle, shown schematically in FIG. 2, comprises:
a first heat exchanger 1 configured to operate as an evaporator,
a second heat exchanger 2 configured to operate as an evaporator,
a third heat exchanger 3 configured to operate selectively as an evaporator or as a condenser,
refrigerant circulation branch A comprising, successively in a direction of circulation of the refrigerant:
   a compressor 7 comprising at least one inlet 7a and one outlet 7b,
   a condenser 8,
   a refrigerant accumulation device 9,
a refrigerant distribution module 50 as described above, comprising a third expansion valve 33 arranged on the seventh channel 17, in which:
   an inlet 1a of the first exchanger 1 is connected to the third outlet S3,
   an outlet 1b of the first exchanger 1 is connected to the third inlet E3,
   an inlet 2a of the second exchanger 2 is connected to the first outlet S1,
   an outlet 2b of the second exchanger 2 is connected to the second inlet E2,
   an inlet 3a of the third exchanger 3 is connected to the fourth outlet S4,
   an outlet 3b of the third exchanger 3 is connected to the fourth inlet E4,
   the inlet 7a of the compressor 7 is connected to the second outlet S2, and
   the outlet of the refrigerant accumulation device 9 is connected to the first inlet E1.

According to this embodiment, the number of components of the thermal conditioning system 100 not forming part of the refrigerant distribution module 50 is further reduced.

The thermal conditioning system 100 described may operate in many operating modes, depending on how the two shut-off valves 5, 6 and the two expansion valves 31, 32 are controlled.

The thermal conditioning system 100 may selectively operate in various operating modes, such as in heat pump mode, in vehicle interior cooling mode, and in powertrain cooling mode.

In heat pump mode, the refrigerant circulates successively through the compressor 7, the condenser 8, the third expansion valve 33 where it becomes low-pressure refrigerant, through the third exchanger 3 where it evaporates and receives heat from the external air stream Fe. The essentially gaseous refrigerant enters the module 50 through the fourth inlet E4, leaves through the second outlet S2 and reaches the inlet 7a of the compressor 7, which completes the thermodynamic cycle.

The heat of condensation in the exchanger 8 makes it possible to heat the vehicle interior.

In vehicle interior cooling mode, the refrigerant circulates successively through the compressor 7, the condenser 8, the third expansion valve 33 without undergoing expansion, through the third exchanger 3 where it condenses, giving up heat to the external air stream Fe. The refrigerant, essentially in liquid form, enters the module 50 through the fourth inlet E4, circulates through the sixth channel 16, through a part of the filter 30, through the first expansion valve 31 where it becomes low-pressure refrigerant, and leaves the module through the first outlet S1. From there, the refrigerant is evaporated in the second exchanger 2, which cools the internal air stream Fi. The refrigerant from the second exchanger 2 enters the module 50 through the second inlet E2, and circulates through the second channel 12 to the second outlet S2. From there, the refrigerant reaches the compressor inlet, as before.

The heat of condensation of the refrigerant is dissipated in the condenser 8 and in the third exchanger 3. The heat of evaporation of the refrigerant is taken from the internal air stream Fi in the second exchanger 2.

In powertrain cooling mode, the circulation of the refrigerant between the outlet 7b of the compressor 7 and the filter 30 is identical to the previous mode. In the first connection zone C1, the refrigerant circulates through the third channel 13, then through the second expansion valve 32 where it becomes low-pressure refrigerant, through the first exchanger 1 where it evaporates, absorbing heat, then through the fourth channel 14, then the portion of the second channel 12 extending between the second connection zone C2 and the third connection zone C3, and reaches the second outlet S2. From there, the refrigerant reaches the compressor inlet, as before.

1. A refrigerant distribution module, comprising:
a first refrigerant circulation channel, connecting a first refrigerant inlet and a first refrigerant outlet;
a second circulation channel connecting a second inlet and a second outlet;
a third circulation channel connecting a first connection zone arranged on the first channel and a third outlet;
a fourth circulation channel connecting a third inlet and a second connection zone arranged on the second channel between the second inlet and the second outlet;
a fifth circulation channel connecting a fourth inlet and a third connection zone arranged on the second channel between the second connection zone and the second outlet; and
a sixth circulation channel connecting a fourth connection zone arranged on the fifth channel and a fifth connection zone arranged on the first channel between the first inlet and the first connection zone,
wherein the sixth channel comprising a one-way valve configured to allow circulation of refrigerant from the fourth connection zone to the fifth connection zone and configured to prevent circulation of refrigerant from the fifth connection zone to the fourth connection zone,
wherein each refrigerant circulation channel is formed by an internal recess of a same basic block.

2. The refrigerant distribution module as claimed in claim 1, comprising a seventh circulation channel connecting a fourth outlet and a sixth connection zone arranged on the first channel between the fifth connection zone and the first inlet.

3. The refrigerant distribution module as claimed in claim 1,
wherein the first channel comprises a first expansion valve arranged between the first connection zone and the first outlet, and
wherein the third channel comprises a second expansion valve.

4. The refrigerant distribution module as claimed in claim 1,
wherein the first channel comprises a first shut-off valve arranged between the first inlet and the fifth connection zone, and
wherein the fifth channel comprises a second shut-off valve arranged between the fourth connection zone and the third connection zone.

5. The refrigerant distribution module as claimed in claim 1, wherein the basic block has substantially a shape of a rectangular parallelepiped.

6. The refrigerant distribution module as claimed in claim 1, wherein the refrigerant circulation channels are formed by a succession of straight cylindrical portions in fluidic communication with one another.

7. The refrigerant distribution module as claimed in claim 1, wherein each refrigerant circulation channel is formed by a succession of coaxial cylindrical portions or cylindrical portions extending along intersecting axes.

8. The refrigerant distribution module as claimed in claim 1,
wherein the first channel of the basic block comprises a first housing for receiving a first expansion valve,
wherein the first housing is cylindrical and extending along an axis, and
wherein the first channel opens into the first housing,
wherein the axis of the first housing is not concurrent with the axis of the first channel.

9. The refrigerant distribution module as claimed in claim 1,
wherein the second inlet and the second outlet are arranged on a first face of the basic block,
wherein the third inlet and the third outlet are arranged on a second face of the basic block,
wherein the first outlet is arranged on a third face of the basic block, and
wherein the first face, the second face and the third face are perpendicular in pairs.

10. The refrigerant distribution module as claimed in claim 1, of the preceding claims, wherein a housing for receiving a first expansion valve and a housing for receiving a second expansion valve open onto the same face of the basic block.

11. The refrigerant distribution module as claimed in claim 1,
wherein the second channel comprises a refrigerant pressure sensor arranged between the second connection zone and the third connection zone,
wherein the second channel comprises a refrigerant temperature sensor arranged between the third connection zone and the second outlet, and
wherein the refrigerant pressure sensor and the refrigerant temperature sensor are arranged on a fourth face of the basic block, opposite the third face.

12. The refrigerant distribution module as claimed in claim 1, further comprising an interface flange forming an interface with a first heat exchanger,
wherein the interface flange comprising:
a first transfer channel connecting the third outlet of the module to a refrigerant inlet of the first heat exchanger; and
a second transfer channel connecting an outlet of the first heat exchanger and the third inlet of the module,
wherein the interface flange is rigidly secured to the basic block and the first heat exchanger.

13. The refrigerant distribution module as claimed in claim 1, further comprising a first heat exchanger arranged in an extension of the basic block of the refrigerant distribution module.

14. A thermal conditioning system for a motor vehicle, comprising:
a first heat exchanger configured to operate as an evaporator;
a second heat exchanger configured to operate as an evaporator;
a refrigerant distribution module as claimed in claim 1, in which:
an inlet of the first exchanger is connected to the third outlet,
an outlet of the first exchanger is connected to the third inlet,
an inlet of the second exchanger is connected to the first outlet,
an outlet of the second exchanger is connected to the second inlet;
a first refrigerant circulation branch comprising, successively in a direction of circulation of the refrigerant:
a compressor comprising at least one inlet and one outlet,
a condenser,
a third expansion device,
a third heat exchanger configured to operate selectively as an evaporator or as a condenser,
wherein an outlet of the third exchanger is connected to the fourth inlet of the distribution module, and the inlet of the compressor is connected to the second outlet; and
a second refrigerant circulation branch, connecting a junction point arranged on the first circulation branch to the first inlet of the distribution module.

15. The thermal conditioning system as claimed in claim 14
wherein the first exchanger is configured to be thermally coupled to an element of an electric powertrain of a motor vehicle,
wherein the second heat exchanger is configured to exchange heat with an internal air stream inside a vehicle interior,
wherein the third heat exchanger is configured to exchange heat with an internal air stream inside a vehicle interior.
